(19) United States
(12) Patent Application Publication
(10) Pub. No.: US 2005/0072533 A1
(43) Pub. Date: Apr. 7, 2005

(54) Shutter system and method of installing same

(76) Inventor: Alan J. Vincent, Naples, FL (US)

Correspondence Address: Daniel C. Crilly, Esq.;Brinkley, McNemey, Morgan, Solomon & Tatum, LLP, Suite 1900, 200 E. Las Olas Blvd., Fort Lauderdlale, FL, 33301, US

(21) Appl. No.: 10/677,806

(22) Filed: Oct. 2, 2003

(51) Int. Cl. E06B 9/08

(52) U.S. Cl. 160/133

(57) ABSTRACT

A shutter system for covering a wall opening includes a retractable and deployable barrier assembly and at least one pair of cooperating support braces. The barrier assembly and each brace define respective holes for receiving fasteners that will be used to attach the pair(s) of braces together to reinforce the barrier assembly. When deployed, the barrier assembly covers the wall opening and defines an inside surface proximate the wall opening and an outside surface facing the source of any displacement forces. Each pair of support braces includes an interior brace that is mountable within the wall opening and an exterior brace constructed for positioning against the outside surface of the barrier assembly. The fasteners are inserted through the holes in the exterior support braces, then through the holes in the barrier assembly, and finally through the holes in the interior support braces during use of the system.

### FIELD OF THE INVENTION

The present invention relates generally to storm shutter systems for covering openings in walls of buildings and, more particularly, to a retractable/deployable storm shutter system that utilizes reinforcing braces to provide additional support against large displacement forces, such as those that arise during thunderstorms, tropical storms, hurricanes, tornados or other events.

### BACKGROUND OF THE INVENTION

Storm shutter systems are well known. Such systems are typically used to cover and protect windows, doors, and other openings in buildings from flying debris and other displacement forces that result from strong storms, such as severe thunderstorms, hurricanes, tropical storms, and typhoons. Basic shutter systems include a barrier assembly made up of corrugated steel panels that are fastened over the wall openings using threaded bolts that screw into anchors recessed in the walls of the building. Other basic systems also use corrugated panels, but instead of recessed anchors, such systems use rails that are secured to the building above and below the opening. The panels are inserted along the rails and are secured to the rails with bolts and wing nuts.

While storm panels are useful in protecting the building's openings, they have certain disadvantages. For example, steel panels are relatively heavy, weighing approximately two pounds per square foot. Thus, such panels become difficult to install on a two or three story dwelling, particularly when the homeowner must carry each panel necessary to cover the upper story windows up a ladder and onto a roof. Making the upper story installation even more difficult is the common use of wavy, Spanish tile roofs on many homes in geographical areas that are more prone to be in the paths of hurricanes or other strong storms.

Other more sophisticated storm shutter systems are also commercially available. One such system is referred to as an accordion shutter system. In an accordion shutter system, rails are installed above and below the wall opening, and a flexible, corrugated panel is permanently installed just outside each vertical end of the opening such that the panels, when deployed, can slide in the track created by the rails. When not in use, the panels are in a collapsed or compressed state and reside adjacent the vertical ends of the opening. To use, the user manually pulls or deploys each panel toward the center of the opening and locks the two panels together with a small padlock or other locking mechanism to keep them in place. When the storm has passed, the lock is removed and the user manually pushes or retracts the panels into their collapsed positions adjacent the vertical ends of the opening. Since the accordion panels are permanently installed, they need not be physically carried to and from their intended location before and after use.

Another more sophisticated shutter system is commonly referred to as a roller system or a rolling shutter system. In this system, the panels and anchors or rails of basic and accordion systems are replaced with a different barrier assembly made up of a series of interlocking steel or aluminum alloy slats that are wound around a motorized roller or reel. The roller resides in a housing that is mounted to the building just above the opening to be protected. Guide rails are also mounted on each vertical end of the opening to guide the movement of the slats during deployment and retraction. The motor is electrically controlled and deploys the slats to cover the building's opening upon activation thereof. Subsequent activation of the motor causes the motor to retract the slats and restore them on the roller. A motorized roller and its associated housing are permanently installed above every opening to be covered by the system.

When a storm is approaching and a property owner does not have a storm shutter system, such owner may resort to the use of plywood to cover the openings in the building. Plywood is commonly fixed to the building by nailing the plywood to the outer surface of the building or by using fasteners inserted into a set of anchors that are embedded in the outer wall of the building. When installed properly, plywood can be an effective protective covering for building openings. However, plywood is difficult to nail into concrete and improper nailing close to an edge of the opening can create chips in the wall that render the opening more difficult to protect and reduce the holding power of the plywood to the building. If the plywood is not properly supported, a displacement force, such as high velocity wind, can rip the plywood away from the building. Not only does this leave the opening and the interior of the building unprotected, but it also creates another projectile that can cause personal injury or damage to property.

While plywood and commercial storm shutter systems provide some storm protection, their protection capabilities are limited. Storm shutter systems are typically rated to withstand displacement forces associated with threshold wind speeds. The threshold wind speeds are typically established by testing the performance of the shutter systems in wind tunnels, wherein various sized items are projected at the shutters at various wind speeds. The wind speed limitation of such systems is generally determined by the strength of the shutters. Most shutter systems are rated to withstand displacement forces associated with wind speeds of approximately 155 miles per hour. Such wind speeds are equivalent to maximum sustained wind speeds associated with a Category 4 hurricane on the Saffir-Simpson scale. However, anyone living in a geographical area in which hurricanes are prevalent knows that hurricanes can rise to the level of Category 5 on the Saffir-Simpson scale. A Category 5 hurricane can have sustained winds of greater than 155 miles per hour. Thus, conventional shutter systems are not typically rated to withstand a Category 5 hurricane.

Various approaches have been proposed in order to provide additional support or reinforcement to the barrier assembly of plywood or paneled systems in an attempt to increase the strength of the assembly. One such approach is disclosed in U.S. Pat. No. 5,722,206 issued to McDonald. McDonald describes a flexible storm resistant system that uses at least two hinged support braces on the interior of a panel and a corresponding number of splints on the exterior of the panel. The hinged support braces have retaining devices (e.g., bolts) that protrude outward horizontally from the support braces. The protruding retaining devices extend through the panel and through the exterior splints, where they are secured on the exterior side of the panel and splints with a washer and a nut. The protruding retaining devices allow panels containing a predetermined pattern of holes associated with the locations of the retaining devices to be placed upon the retaining devices as necessary to achieve a desired panel configuration over the opening. Each pair of hinged support braces and splints sandwiches the plywood or panel to reinforce the panel and mitigate the likelihood of structural failure due to vibration and impact from flying debris during very strong storms, such as hurricanes.

While the McDonald system provides a mechanism for increasing the strength of the barrier assembly for paneled shutter systems, the McDonald system cannot work with a rolling shutter system or an accordion shutter system because the retaining devices (e.g., bolts) protruding outwardly from the hinged support braces prevent the user from deploying the slats of the rolling shutter system or the panels of the accordion shutter system. That is, because the retaining devices in the McDonald system emanate from the wall opening to enable the shutter panels to be placed over them during use, such devices would interfere with the slats of the rolling shutter system and the panels of the accordion shutter system as such slats or panels were respectively deployed.

Therefore, a need exists for a shutter system and associated method of installation that increases the resistance and resilience of the system's barrier assembly while facilitating use in a rolling shutter system and/or an accordion shutter system.

### BRIEF DESCRIPTION OF THE DRAWINGS

FIG. 1 is an exploded and perspective view of a shutter system in accordance with a rolling shutter system embodiment of the present invention.

FIG. 2 is a cut-away side view of the shutter system of FIG. 1 after such system has been installed in or on a building.

FIG. 3 is an exploded and perspective view of a shutter system in accordance with an accordion shutter system embodiment of the present invention.

### DETAILED DESCRIPTION OF PREFERRED EMBODIMENTS

Generally, the present invention encompasses a shutter system and associated installation method for use in protecting building wall openings from flying debris during thunderstorms, tropical storms, hurricanes, tornados or other events. The shutter system includes a retractable/deployable barrier assembly and at least one pair of cooperating support braces. In one embodiment, the barrier assembly includes a series of interlocking slats that are preferably deployed and retracted from a motorized roller or reel in accordance with well-known rolling shutter techniques. In another embodiment, the barrier assembly includes a pair of flexible panels that are deployed and retracted manually in opposite horizontal directions across the opening in accordance with well-known accordion shutter techniques.

The barrier assembly defines holes for receiving fasteners that will be used to attach the pair(s) of cooperating braces together such that the braces sandwich and reinforce the assembly. When deployed, the barrier assembly covers the wall opening and defines inside and outside surfaces, with the inside surface being proximate the wall opening and the outside surface facing the source of any displacement force.

Each pair of cooperating support braces includes an interior brace and an exterior brace. Each interior brace is mountable within the wall opening and defines a set of holes for receiving the fasteners after they pass through the barrier assembly. Each exterior brace is constructed for positioning against the outside surface of the barrier assembly after deployment of the barrier assembly, and also defines a set of holes for receiving the fasteners as they initially penetrate the system. The fasteners, such as threaded bolts, are preferably inserted through the holes in the exterior support braces, then through the holes in the barrier assembly, and finally through the holes in the interior support braces into wing nuts or other retention devices to completely assemble the system during use thereof.

By providing a shutter system in this manner, the present invention increases the displacement force loads that can be withheld by the retractable/deployable barrier assembly due the reinforcing action of the cooperating braces. Moreover, the present invention provides such a reinforced system in the context of a rolling shutter system and/or an accordion shutter system, as opposed to a particular basic shutter system as has been provided in the prior art.

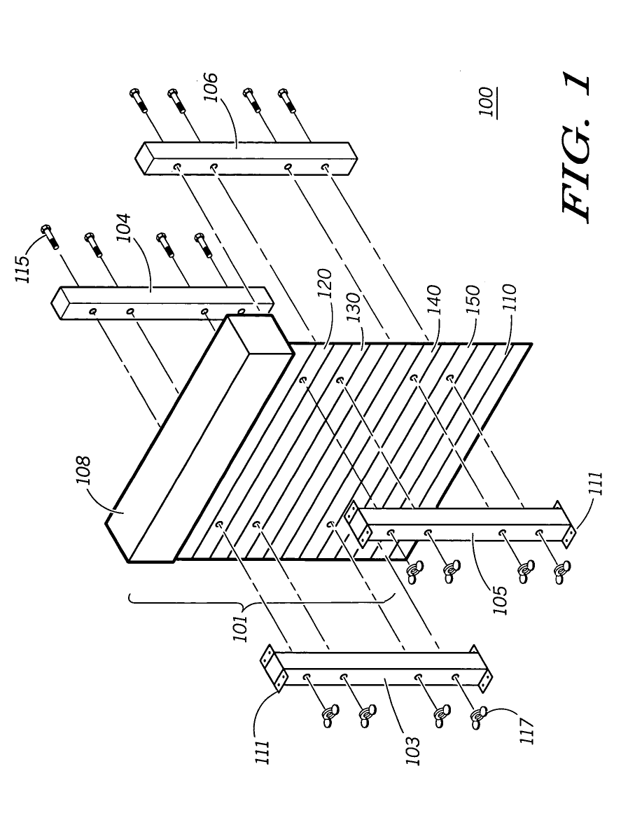

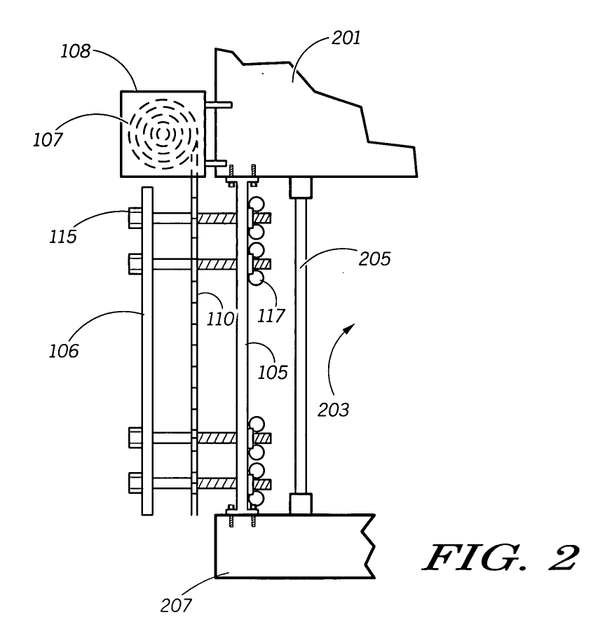

The present invention can be more fully understood with reference to FIGS. 1-3, in which like reference numerals designate like items. FIG. 1 is an exploded and perspective view of a shutter system 100 in accordance with a rolling shutter system embodiment of the present invention. The depicted shutter system 100 includes a retractable and deployable barrier assembly 101 and at least one pair of cooperating support braces 103-106 (two pairs are shown in FIG. 1). The barrier assembly 101 preferably includes a motorized roller or reel 107 (shown in phantom in FIG. 2) and a series of interlocking horizontal slats 110 that deploy from and retract into, as applicable, the roller 107 and/or its associated housing 108. When deployed, the slats 110 cover an opening in the wall of a building such that the inside surfaces of the slats 110, which together define an inside surface of the barrier assembly 101, are proximate the opening 203 and the outside surfaces of the slats 110, which together define an outside surface of the barrier assembly 101, are positioned to receive any displacement forces that may be exerted against the barrier assembly 101. The motorized roller 107 is constructed in accordance with conventional techniques to retain the slats 110 in a rolled configuration until deployment is desired and to deploy the slats 110 upon activation by a user such that the slats 110 cover an opening in the wall to which the motor housing 108 is mounted.

Each of the slats 110 is preferably fabricated in a conventional manner from high strength aluminum alloy (e.g., 6063-T5 or 6063-T6 extruded aluminum alloy manufactured by Aluminio Dominicano of Santo Domingo, Dominican Republic or various other manufacturers), steel, high strength plexiglass, or any other material capable of withstanding a desired level of displacement forces (e.g., those associated with wind speeds up to approximately 155 miles per hour). When deployed, the series of slats 110 have a periphery larger than the wall opening that the slats 110 are intended to shield to prevent, or at least substantially impede, any projectiles or other displacement forces from entering the opening.

The support braces 103-106 are preferably fabricated from high strength aluminum alloy (e.g., 6063-T6 extruded aluminum alloy) or steel and have a rectangular cross-section preferably in the range of approximately four square inches to approximately 10 square inches (approximately 25 square centimeters to approximately 65 square centimeters). The length or height of each support brace 103-106 preferably coincides approximately with the length or height of the wall opening. The quantity of pairs of cooperating support braces 103-106 that are used, and their associated cross-sectional areas, depend upon the size of the wall opening to be covered by the barrier assembly 101 and the displacement force or pressure to be resisted. For example, a single hung window may require only one pair of cooperating support braces; whereas, two side-by-side single hung windows, a set of French doors or a sliding glass door may require two pairs of cooperating support braces mounted in a parallel or substantially parallel configuration. Alternatively, a triple sliding glass door or some other larger opening may require three or four pairs of cooperating support braces. In a preferred embodiment, one pair of support braces (e.g., 103, 104) is used for approximately every three to four linear feet (approximately 0.9 to 1.22 meters) of wall opening. The cross-sectional area of each brace 103-106 is selected using conventional impact pressure calculations and is preferably in the range of four square inches (approximately 26 square millimeters) to ten square inches (approximately 64 square millimeters) depending on the quantity of pairs of braces 103-104, 105-106 used, the distance between each pair of braces 103-104, 105-106, the height of each brace 103-106, and the desired impact load for the shutter system 100.

One brace 103, 105 (interior brace) of each pair of support braces 103-106 includes anchor members 111 to enable the brace 103, 105 to be securely mounted at the top and bottom to the building and/or slab (e.g., using TAPCON concrete screws), as applicable. The other brace 104, 106 (exterior brace) of each pair of support braces 103-106 is loose or free, but constructed to be positioned against the outside surfaces of the slats 110 (i.e., the outside surface of the barrier assembly 101).

Each brace 103-106 includes a set of holes for receiving a corresponding set of fasteners. The set of holes are also fabricated into some of the slats (e.g., slats 120, 130, 140, 150) of the barrier assembly 101 to permit the fasteners to pass through the slats 120, 130, 140, 150 during use of the shutter system 100.

In the preferred embodiment, the fasteners are threaded carriage bolts and wing nuts. In an alternative embodiment, the fasteners might comprise only threaded bolts—for example, when the interior support braces 103, 105 include pre-fabricated threads for receiving the bolts. One of ordinary skill in the art will readily recognize that various fastening systems may be utilized in order to secure the exterior support braces 104, 106 to the interior support braces 103, 105 such that the slats 110 of the barrier assembly 101 are sandwiched between each pair of cooperating braces 103-106.

Installation of shutter system 100 may be understood with reference to FIGS. 1 and 2. The motorized roller 107 and its associated housing 108 are mounted to the wall 201 of the building just above the opening 203 in accordance with conventional techniques. In addition, guide rails or tracks (not shown) are preferably mounted along or just outside opposing vertical edges of the opening 203 to guide the travel of the slats 110 as they are deployed and retracted. The roller 107 retains the slats 110 in a rolled configuration until the slats 110 are deployed by a user of the system 100 to cover the opening 203. When the deployed slats 110 are no longer needed to protect the opening 203, the motorized roller 107 is activated by the system user to retract the slats 110 and restore them in the rolled configuration. The opening 203 may be covered by a window, a sliding glass door, French doors, or any other covering 205 that is typically not resistant to high-speed projectiles or large displacement forces.

The interior support brace 105 of each pair of support braces 105, 106 (only one pair of support braces 105, 106 is depicted in FIG. 2) is mounted within the opening 203 to the wall 201 and/or a slab 207 that together at least partially define the opening 203. The interior brace 105 is secured to the wall 201 and/or the slab 207 through use of appropriate fasteners, such as TAPCON concrete screws. In FIG. 2, the interior brace 105 is depicted as being mounted to the wall 201 and the slab 207, such as would preferably be the case when the brace 105 was installed in an opening 203 for a doorway (e.g., a sliding glass door). In an alternative embodiment, the interior brace 105 may be secured at its top and bottom to the wall 201 only, as would be the case when the brace 105 was installed in an opening 203 for a window.

In addition to securing the barrier assembly 101 and the interior braces 105 to the building, the exterior braces 106 and fasteners are provided to the system user for use in performing final assembly of the system 100 on an as-needed basis. As discussed above, when the slats 110 are deployed by the user, the slats 110 cover the opening 203 such that the inside surfaces of the slats 110 are proximate the opening 203. Each exterior brace 106 is constructed to be positioned against the outside surfaces of the slats 110. Each interior brace 105, each exterior brace 106 and some of the slats 120, 130, 140, 150 include holes or apertures that permit the fasteners to pass from the free, exterior brace 106 through the slats 120, 130, 140, 150 to the mounted, interior brace 105 to secure the interior brace 105 and the exterior brace 106 to the barrier assembly 101, such that the slats 110 are sandwiched between the braces 105, 106. In a preferred embodiment, the fasteners consist of threaded bolts 115 and wing nuts 117.

During use of the shutter system 100, the user aligns the holes in the exterior braces 104, 106 with the corresponding holes in predetermined slats 120, 130, 140, 150 of the barrier assembly 101. The user then inserts the bolts 115 first through the holes in each exterior brace 104, 106, then through the holes in the slats 120, 130, 140, 150 and finally through the matching holes in each interior brace 103, 105. The wing nuts 117 are then screwed and tightened onto the ends of the bolts 115 that are protruding through the interior braces 103, 105 to secure the interior braces 103, 105 and their associated exterior braces 104, 106 to the barrier assembly 101. Once the fasteners are tightened, each pair of braces 103-106 sandwiches the slats 110 of the barrier assembly 101 between them and cooperates with one another to provide additional strength and support to the barrier assembly 101 during exertion of displacement forces against the outside surfaces of the slats 110.

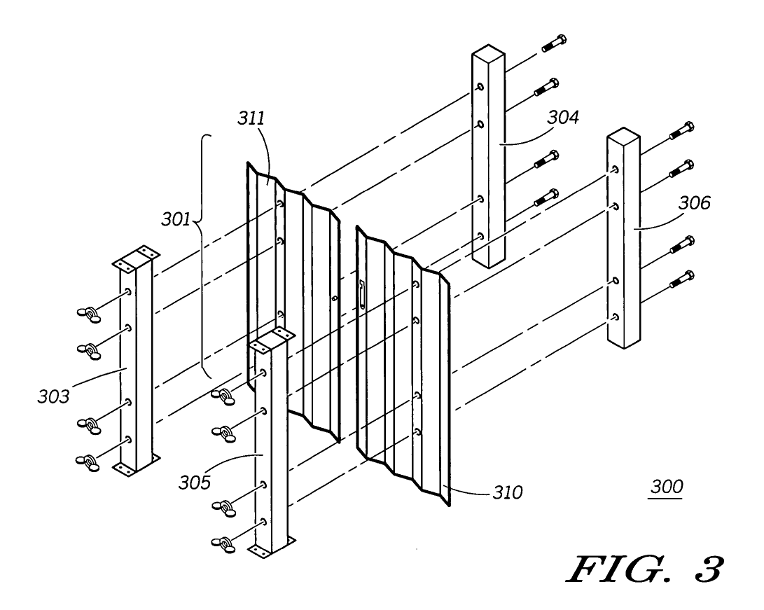

FIG. 3 is an exploded and perspective view of a shutter system 300 in accordance with an accordion shutter system embodiment of the present invention. Similar to the shutter system 100 depicted in FIG. 1, the shutter system 300 depicted in FIG. 3 includes a retractable and deployable barrier assembly 301 and at least one pair of cooperating support braces 303-306 (two pairs are shown in FIG. 3). The barrier assembly 301 preferably includes two guide rails or tracks (not shown) and a pair of flexible, preferably corrugated panels 310, 311 mountable just outside opposing vertical ends or edges of the applicable wall opening. Alternatively, the panels 310, 311 may comprise a series of interlocking vertical slats analogous to the interlocking horizontal slats 110 used to implement at least part of the barrier assembly 101 of FIG. 1. When not in use, the panels 310, 311 are in collapsed, compressed or rolled (e.g., when using interlocking slats to form the panels 310, 311) configurations at their mounted positions. To deploy the panels 310, 311, the user pushes or pulls each panel 310, 311 toward the center of the opening such that the panels 310, 311 travel along their respective rails into expanded or open positions. Once the panels 310, 311 have been deployed, the user preferably locks the panels 310, 311 together using a small padlock or other mechanism (not shown) in accordance with conventional accordion shutter system techniques. To retract the panels 310, 311 after their use is no longer necessary, the user unlocks the locking mechanism and pushes or pulls the panels 310, 311 along their respective rails back to their mounted, non-use positions at the vertical edges of the opening.

When deployed, the panels 310, 311 cover the opening in the wall such that the inside surfaces of the panels 310, 311, which together define an inside surface of the barrier assembly 301, are proximate the opening and the outside surfaces of the panels 310, 311, which together define an outside surface of the barrier assembly 301, are positioned to receive any displacement forces that may be exerted against the barrier assembly 301.

Each of the panels 310, 311 is preferably fabricated in a conventional manner from high strength aluminum alloy (e.g., 6063-T5 or 6063-T6 extruded aluminum alloy), steel, high strength plexiglass, or any other material capable of withstanding a desired level of displacement forces (e.g., those associated with wind speeds of up to approximately 155 miles per hour). When deployed, the pair of panels 310, 311 have a periphery larger than the wall opening that the panels 310, 311 are intended to shield to prevent, or at least substantially impede, any projectiles or other displacement forces from entering the opening.

The support braces 303-306 and the fasteners used to attach the support braces 303-306 and the panels 310, 311 together are preferably identical to the braces 103-106 and the fasteners described in detail above with respect to FIG. 1. Thus, the panels 310, 311 and the braces 303-306 each define a set of holes or other apertures for receiving the fasteners during use of the system 300.

Installation and use of the shutter system 300 of FIG. 3 is similar to the above-described installation and use of the shutter system 100 of FIG. 1 with the following exceptions. The panels 310, 311 are mounted just outside opposing vertical edges of the opening 203 instead of just above the opening 203 as was the housing 108 of the barrier assembly 101 of FIG. 1. Accordingly, tracks and/or guide rails (not shown) for guiding the travel of the panels 310, 311 are mounted along or just outside opposing horizontal edges of the opening 203 instead of along or just outside opposing vertical edges of the opening 203 as was the case for the barrier assembly 101 of FIG. 1.

As described above, the present invention encompasses a shutter system and associated installation method for use in protecting building wall openings from damage during exertion of large displacement forces, such as during thunderstorms, tropical storms, hurricanes, tornados or other events. The shutter system of the present invention increases the displacement force loads that can be withheld by a retractable/deployable barrier assembly due the reinforcing action of cooperating braces that sandwich the barrier assembly during use. Moreover, the present invention provides such a reinforced system in the context of a rolling shutter system and/or an accordion shutter system, in contrast to reinforcement that is limited to panel shutter systems as is disclosed in the prior art.

In the foregoing specification, the present invention has been described with reference to specific embodiments. However, one of ordinary skill in the art will appreciate that various modifications and changes may be made without departing from the spirit and scope of the present invention as set forth in the appended claims. For example, additional pairs of mountable braces and cooperating braces may be utilized depending on the size of the wall opening to be protected. In addition, the roller 107 that retains the slats 110 of the barrier assembly 101 of FIG. 1 may be spring-loaded instead of motorized to facilitate manual deployment and retraction of the barrier assembly 101. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. As used herein and in the appended claims, the terms “comprises,” “comprising” or any other variation thereof is intended to refer to a non-exclusive inclusion, such that a process, method, apparatus, or article of manufacture that comprises a list of elements does not include only those elements in the list, but may include other elements not expressly listed or inherent to such process, method, apparatus, or article of manufacture.

1. A shutter system for covering an opening in a wall of a building, the shutter system comprising:
a retractable and deployable barrier assembly having a periphery larger than the opening in the wall when the barrier assembly is deployed, the barrier assembly defining a plurality of holes for receiving a corresponding plurality of fasteners and further defining an inside surface and an outside surface, the inside surface of the barrier assembly being positioned proximate the opening in the wall after deployment of the barrier assembly;
at least a first support brace mountable within the opening and defining a plurality of holes for receiving the plurality of fasteners, the at least a first support brace being constructed to be positioned against the inside surface of the barrier assembly after deployment of the barrier assembly; and
at least a second support brace constructed to be positioned against the outside surface of the barrier assembly after deployment of the barrier assembly, the at least a second support brace defining a plurality of holes for receiving the plurality of fasteners as the fasteners initially penetrate the shutter system, whereby the at least a first support brace and the at least a second support brace cooperate with the barrier assembly to provide additional support to the barrier assembly during exertion of a displacement force against the outside surface of the barrier assembly.

2. The shutter system of claim 1, wherein the barrier assembly comprises a plurality of interlocking slats and wherein at least some of the plurality of slats define a plurality of holes for receiving the plurality of fasteners, the plurality of slats further defining the inside surface and the outside surface of the barrier assembly.

3. The shutter system of claim 2, wherein the barrier assembly further comprises a motorized roller constructed to retain the plurality of slats in a rolled configuration until deployment is desired and to deploy the plurality of slats upon activation by a user such that the plurality of slats cover the opening in the wall.

4. The shutter system of claim 1, wherein the barrier assembly comprises a pair of flexible panels and wherein each of the panels defines a corresponding plurality of holes for receiving a corresponding set of the plurality of fasteners, the panels further defining the inside surface and the outside surface of the barrier assembly.

5. The shutter system of claim 1, wherein the plurality of fasteners comprises a plurality of threaded bolts and wherein the plurality of holes defined by the at least a first support brace include threads for receiving the plurality of threaded bolts.

6. The shutter system of claim 1, wherein at least one of the barrier assembly, the at least a first support brace, and the at least a second support brace comprises steel.

7. The shutter system of claim 1, wherein at least one of the barrier assembly, the at least a first support brace, and the at least a second support brace comprises an aluminum alloy.

8. The shutter system of claim 1, further comprising the plurality of fasteners.

9. The shutter system of claim 8, wherein the plurality of fasteners comprises a plurality of threaded bolts and a corresponding plurality of wing nuts.

10. A shutter system for covering an opening in a wall of a building, the shutter system comprising:
a retractable and deployable barrier assembly having a periphery larger than the opening in the wall when the barrier assembly is deployed, the barrier assembly defining a plurality of holes for receiving a corresponding plurality of fasteners and further defining an inside surface and an outside surface, the inside surface of the barrier assembly being positioned proximate the opening in the wall after deployment of the barrier assembly;
a first plurality of support braces mountable in a parallel configuration within the opening in the wall, each of the first plurality of support braces defining a respective plurality of holes for receiving at least some of the plurality of fasteners, each of the first plurality of support braces being constructed to be positioned against the inside surface of the barrier assembly after deployment of the barrier assembly; and
a second plurality of support braces mountable in a parallel configuration corresponding to the parallel configuration of the first plurality of support braces, the second plurality of support braces being constructed to be positioned against the outside surface of the barrier assembly after deployment of the barrier assembly, each of the second plurality of support braces defining a respective plurality of holes for receiving at least some of the plurality of fasteners as the fasteners initially penetrate the shutter system, whereby the first plurality of support braces and the second plurality of support braces cooperate with the barrier assembly to provide additional support to the barrier assembly during exertion of a displacement force against the outside surface of the barrier assembly.

11. The shutter system of claim 10, wherein the barrier assembly comprises a plurality of interlocking slats and wherein at least some of the plurality of slats define a plurality of holes for receiving the plurality of fasteners, the plurality of slats further defining the inside surface and the outside surface of the barrier assembly.

12. The shutter system of claim 11, wherein the barrier assembly further comprises a motorized roller constructed to retain the plurality of slats in a rolled configuration until deployment is desired and to deploy the plurality of slats upon activation by a user such that the plurality of slats cover the opening in the wall.

13. The shutter system of claim 10, wherein the barrier assembly comprises at least two flexible panels and wherein each of the panels defines a corresponding plurality of holes for receiving a corresponding set of the plurality of fasteners, the panels further defining the inside surface and the outside surface of the barrier assembly.

14. The shutter system of claim 10, wherein the plurality of fasteners comprises a plurality of threaded bolts and wherein the plurality of holes defined by the first plurality of support braces include threads for receiving the plurality of threaded bolts.

15. The shutter system of claim 10, wherein at least one of the barrier assembly, the first plurality of support braces, and the second plurality of support braces comprises steel.

16. The shutter system of claim 10, wherein at least one of the barrier assembly, the first plurality of support braces, and the second plurality of support braces comprises an aluminum alloy.

17. The shutter system of claim 10, further comprising the plurality of fasteners.

18. The shutter system of claim 17, wherein the plurality of fasteners comprises a plurality of threaded bolts and a corresponding plurality of wing nuts.

19. A method for installing a shutter system to cover an opening in a wall of a building, the method comprising:
providing a plurality of fasteners;
mounting at least a first support brace within the opening in the wall, the at least a first support brace defining a plurality of holes for receiving the plurality of fasteners;
mounting a retractable and deployable barrier assembly to the building, the barrier assembly having a periphery larger than the opening in the wall when the barrier assembly is deployed, the barrier assembly defining a plurality of holes for receiving the plurality of fasteners and further defining an inside surface and an outside surface, the inside surface of the barrier assembly being positioned proximate the opening in the wall after deployment of the barrier assembly; and
providing at least a second support brace constructed to be positioned against the outside surface of the barrier assembly after deployment of the barrier assembly such that the at least a first support brace and the at least a second support brace cooperate with the barrier assembly to provide additional support to the barrier assembly during exertion of a displacement force against the outside surface of the barrier assembly, the at least a second support brace defining a plurality of holes for receiving the plurality of fasteners as the fasteners initially penetrate the shutter system during use of the shutter system.

20. The method of claim 19, wherein the barrier assembly comprises a plurality of interlocking slats, the plurality of slats defining a plurality of holes for receiving the plurality of fasteners.

21. The method of claim 19, wherein the barrier assembly comprises a pair of flexible panels, at least one of the panels defining a plurality of holes for receiving at least some of the plurality of fasteners.
